(19) United States
(12) Patent Application Publication
(10) Pub. No.: US 2012/0193319 A1
(43) Pub. Date: Aug. 2, 2012

(54) Feeding bottle & nipple with ounce/milliliter indicators for filling measurements, and ounce/milliliter indicators for amount remaining measurements that takes into consideration the volume of liquid in the nipple

(76) Inventor: John M. Fortino, JR., Bolingbrook, IL (US)

(21) Appl. No.: 12/931,347

(22) Filed: Jan. 31, 2011

(51) Int. Cl. A61J 9/00; B65D 23/00

(52) U.S. Cl. 215/365

(57) ABSTRACT

This feeding bottle is a bottle that has both filling measurements and amount remaining measurements marked on the sides of the bottle. This bottle takes into consideration the volume in the nipple when feeding so you can accurately view the amount remaining. This feeding bottle allows the user to view how much fluid is remaining in the bottle without stopping the feeding process.

### CROSS-REFERENCE TO RELATED APPLICATIONS

“Not-Applicable”

### STATEMENT REGARDING FEDERALLY SPONSORED R&D

“Not-Applicable”

### REFERENCE TO SEQUENCE LISTING, A TABLE, OF COMPUTER PROGRAM

“Not-Applicable”

### TECHNICAL FIELD

The invention relates to a feeding bottle for example a bottle used to feed a child or infant whether premature or full term.

### BACKGROUND OF THE INVENTION

Conventional feeding bottles comprise a nipple and bottle connected by a screw-on collar. A problem with these bottles is that when the feeder/parent wants to see how much the child has consumed, they have to remove the bottle from the child's mouth. Once the bottle is removed it is difficult for some infants to continue consuming especially if the child has colic, reflux, silent reflux or has poor temperament. Pre-mature babies are supposed to consume specific amounts of formula or breast milk every so often per advice of a professional, conventional bottles do not offer a view of what has been consumed or what is remaining in the bottles while the child is feeding.

I have not been able to find a bottle that offers a view of what is remaining in the bottle while the child is consuming.

### BRIEF SUMMARY OF THE INVENTION

With the ability to view the amount remaining in the feeding bottle, the parent no longer has to stop feeding to see how much the child has consumed; one can easily calculate how many ounces are consumed and therefore reduce the irritation to the infant.

### BRIEF DESCRIPTION OF THE DRAWINGS

FIG. 1 is a front view of a feeding bottle that shows indicators for filling measurements.

FIG. 2 is a back side view of the feeding bottle at a planned feeding angle that shows indicators for amount remaining measurements.

### DETAILED DESCRIPTION OF THE INVENTION OR PREFERRED EMBODIMENT

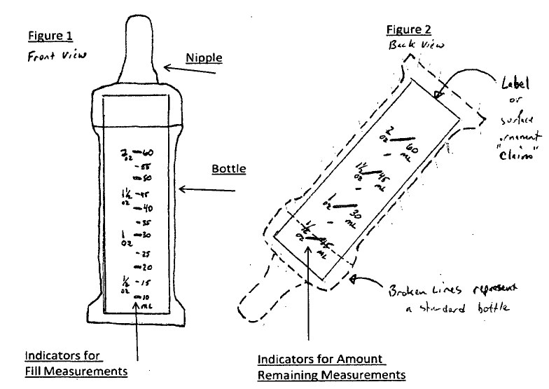

FIG. 1 represents a feeding bottle from the front view that has indicators for ounce/milliliter fill measurements on the bottle via a label or ornamental design printed on the bottle.

FIG. 2 represents a feeding bottle from the back view at an estimated feeding angle that has indicators for ounces/milliliters remaining measurements on the bottle via a label or ornamental design printed on the bottle.

FIG. 2 has broken lines which represent a standard bottle and is not part of the design sought to be patented.

FIG. 2 the solid lines represent the design “claim”.

FIG. 2 These indicators will enable the feeder to align the fluid to the (feeding angle) with remaining indicators to calculate how many ounces/milliliters are left to calculate consumption, as opposed to taking the bottle out of the mouth of the consumer and leveling to the fill indicators (FIG. 1).

FIG. 1 is manufactured by many companies, FIG. 2 can be manufactured with a slight modification to the label or printing of FIG. 1 which will create a new use for parents with children that eat poorly or have a very strict consumption need. There is not a need for any structural changes to the bottle, nipple, or collar, the change in the label or printing will change the way the product is used.

1. The bottle has unique remaining indicators (FIG. 2) that represents the number of ounces/milliliters remaining in the bottle. (Claim) These indicators will enable the feeder to align the fluid to the (feeding angle) with (FIG. 2) remaining indicators to indicate how many ounces/milliliters are left, as opposed to taking the bottle out of the mouth of the consumer and leveling to the fill indicators (FIG. 1). This new bottle will change the way the bottle is used and create a new product for parents with children that eat poorly or have a very strict consumption need or any parent that would like to see how much the consumer has consumed without stopping the feeding process.
